(19) United States
(12) Patent Application Publication
(10) Pub. No.: US 2021/0368764 A1
(43) Pub. Date: Dec. 2, 2021

(54) Multi-Frequency Targeting Insect Control

(71) Applicant: Alliance Sports Group, L.P., Fort Worth, TX (US)

(72) Inventor: Gregory Lee Horne, Euless, TX (US)

(21) Appl. No.: 17/333,727

(22) Filed: May 28, 2021

Related U.S. Application Data
(60) Provisional application No. 63/032,862, filed on Jun. 1, 2020.

(51) Int. Cl. A01M 1/14; A01M 1/10

(52) U.S. Cl. CPC A01M 1/145; A01M 1/106

(57) ABSTRACT

A lighting device is disclosed for use in connection with the extermination of insects. The device has a housing, a power source, and first and second light sources disposed about trap that facilitates extermination of the insect when it encounters the trap. A first light source propagates a wavelength of light ranging from about 370 nm to about 410 nm at a first duty cycle. The second light source propagates a wavelength of light ranging from about 340 nm to about 380 nm at a second duty cycle.

### PRIORITY CLAIM

The present application claims priority to U.S. Ser. No. 63/032,862 filed on Jun. 1, 2020 entitled “Multi-Frequency Targeting Insect Control” which is incorporated herein by reference in its entirety.

### FIELD

The present technology relates to lighting devices. Specifically, multiple use lighting devices and methods of operation and devices for insect extermination.

### BACKGROUND

UV lighting devices used to attract insects for extermination have been previously produced. A limitation with prior art extermination devices is that the light from these devices may be too bright for indoor use and/or too bright for continuous use. Moreover, the prior devices may be limited in versatility to the end user and/or may result in inefficient power consumption. Moreover, optimal UV light frequencies and operational characteristics may be distracting to the end user.

### BRIEF DESCRIPTION OF THE DRAWINGS

To further clarify the above and other aspects of the present technology, a more particular description of the invention will be rendered by reference to specific aspects thereof which are illustrated in the appended drawings. It is appreciated that these drawings depict only typical aspects of the technology and are therefore not to be considered limiting of its scope. The drawings are not drawn to scale. The technology will be described and explained with additional specificity and detail through the use of the accompanying drawings in which:

FIG. 1 is a side view of an extendable flashlight/insect extermination device in accordance with one aspect of the technology;

FIG. 2 is an additional view of the device of FIG. 1;

FIG. 3 is an additional view of the device of FIG. 1;

FIG. 4 is an additional view of the device of FIG. 1;

FIG. 5 is a top view of the device of FIG. 1;

FIG. 6 is a bottom view of the device of FIG. 1;

FIG. 7 is a top perspective view of an insect extermination device in accordance with one aspect of the technology;

FIG. 8 is an exploded view of an insect extermination device in accordance with one aspect of the technology;

FIG. 9 is an electrical schematic in accordance with one aspect of the technology; and

FIG. 10 is a chart illustrating different wavelengths of light.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

The term “flashlight” or “lantern” as used herein is used as an example of a lighting device that may employ the technology herein but should not be construed as limiting what kinds of lighting devices may employ the current technology. As such, the term flashlight should be broadly construed to include hand held lighting devices, headlamps, and other various lighting devices.

An initial overview of the technology is provided below and specific technology embodiments are then described in further detail. This initial summary is intended to aid readers in understanding the technology more quickly, but is not intended to identify key or essential features of the technology, nor is it intended to limit the scope of the claimed subject matter.

Broadly speaking, aspects of the current technology improves insect control systems that attracts, traps, and kills insects that are attracted by light. Advantageously, in one aspect of the technology, less light that is more visible to the human eye is emitted from the device than light that is detectable and attractive to insects. In this manner, the functionality and utility of the device for insect extermination is improved while other utilitarian aspects are preserved. The light from the different light sources may be varied in a number of ways including, but not limited to varied duty cycles, variable power input to any of the light sources, increased numbers of lights within any particular light source, and the like. A combination of these methods is also contemplated herein. The traps used to exterminate the insects once they are attracted to the light can vary from application to application as suits the environment, available resources, or user preference, so long as the trap exterminates the insects at some point in time after they encounter the trap.

For example, in one aspect of the technology, a light source attracts insects to a trap comprising an electrical grid or other conductive surface, where they are electrocuted by touching two wires with a high voltage between them. In one aspect, the electrical grid, or other electrically conductive surface, is housed in a protective cage or plastic shroud, grounded metal bars, or some other material, to prevent people or animals from touching the high voltage grid or electrically conductive surface. In another aspect, the electric grid is located within a housing that is not susceptible to contact and thus does not require a protective cage. In one aspect, a first and second light source are disposed about the protective shroud and are designed to emit/propagate visible light and/or ultraviolet light. In one aspect, a high-voltage power supply powered by electricity, which may be a simple transformerless voltage multiplier circuit made with diodes and capacitors, generates a voltage high enough to conduct through the body of an insect which bridges two grids, but not high enough to spark across the air gap. Enough electric current flows through the small body of the insect to heat it to a high temperature and exterminate it. In one aspect, the voltage level ranges from about 500 to 600 volts. In one aspect, the lighting sources and electrical grid operational options are all operable from a single control switch. In an additional aspect, first and second light sources are located about the protective shroud and are designed to emit ultraviolet light at one frequency that is visible to the human eye and another frequency that is not visible to the human eye. In one aspect of the technology, the plurality of lights in the first or second light sources comprise LED lights that are positioned within a housing and can be within or near the shroud or near the electrically conductive surface. In an aspect where additional light sources are used that emit or propagate visible light, said light sources may be located within the shroud, near the electrically conductive surface, or distally from the electrically conductive surface.

In one aspect, the housing comprises a power source (e.g., a rechargeable battery, non-rechargeable battery, a power cable to an outlet, etc.) and a control circuit capable of regulating the amount of power that is provided to the LED lights. The control module is coupled to external or internal switches that may be operated by a user to change the modes of operation of the different LED lights including, but without limitation, changing the amount of power to the first light source independent of the second light source, changing the amount of power to the second light source independent of the first light source, or simultaneously changing the amount of power to the first and second and light source. In one aspect, the modes of operation indirectly change the power by changing the duty cycle of the LEDs. In another aspect, the power that is provided to the different light sources is increased or decreased by regulating the voltage or other component of electricity, sent to the light sources.

In still another aspect of the technology, the insects are not trapped/exterminated through electrocution. Rather, the insects are exterminated in other traps associated with the housing of the extermination device. In one aspect, the insects are attracted to the housing that includes an adhesive strip where the insects are adhered upon contact and are exterminated through dehydration. In another aspect, the insects are attracted to enter a one-way portal into a chamber that has no exit or that is otherwise difficult to exit. In this manner, the insects are trapped in the chamber and are also exterminated through dehydration. In another aspect, the insects are attracted to a chamber where they are exterminated by the blunt force of a moving blade as disclosed in U.S. Pat. No. 10,701,923, which is incorporated herein by reference in its entirety.

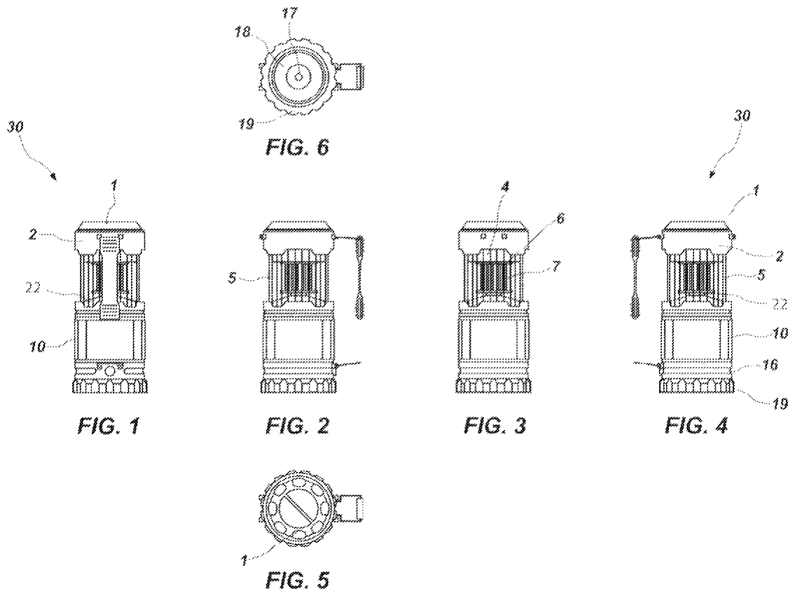

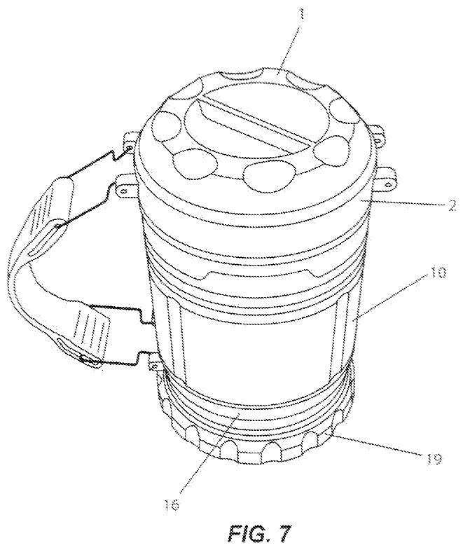

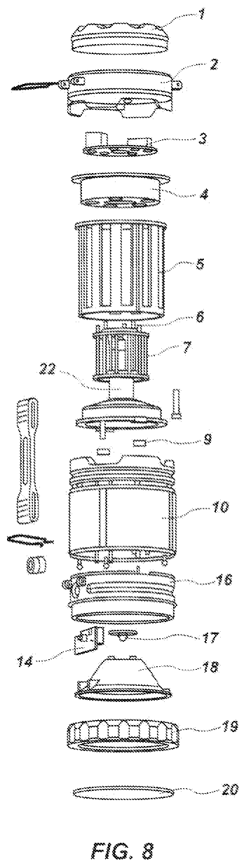

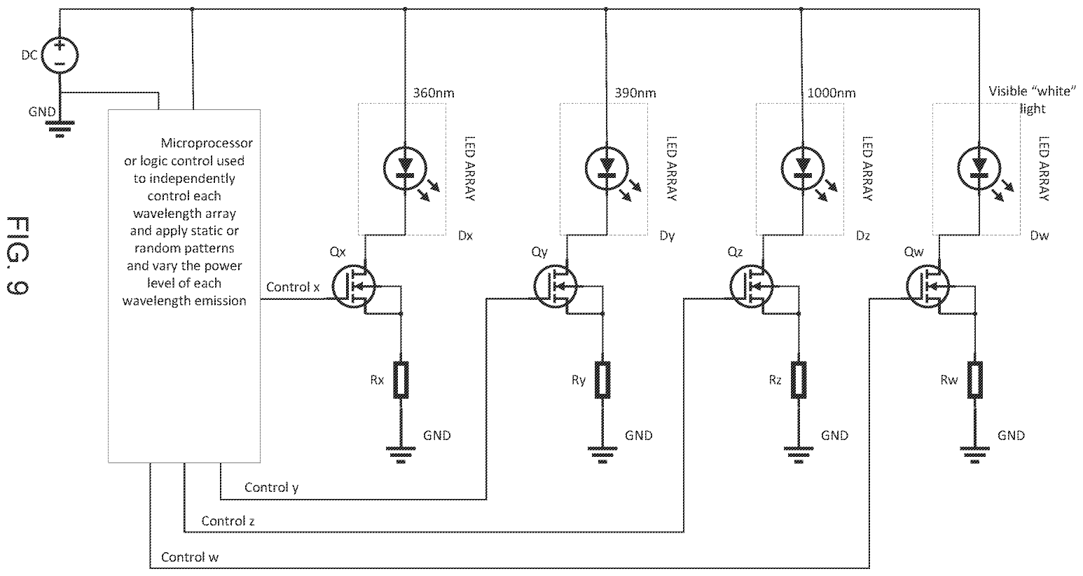

With reference to FIGS. 1 through 8, one example of an insect extermination device is disclosed. In FIGS. 1 through 6, the device 30 is shown in an open position. A first housing or shroud 10 comprises an open end in communication with a cavity. The cavity is configured to house and enclose an electrically conductive surface (e.g., an electrical grid) (6, 7) therein when the device is in a “closed” position (see, e.g., FIG. 7). Meaning, in a closed (or retracted) position the electrical grid (6, 7) is enclosed in the cavity within housing 10 and in an open (or extended) position, the electrical grid (6, 7) is exposed to the ambient environment though it remains covered by shroud 10.

In one aspect of the technology, the first housing or shroud 10 is coupled to a second housing (or lower shroud) 16 which comprises, for example, a forward directed light assembly or light source. In one aspect of the technology, the forward directed light assembly comprises an LED 17 (or other light source) coupled to a control switch 14. The LED 17 is housed within a reflector 18 that is secured within the second housing 16 with capture ring 19. A lens 20 is disposed about the distal end of the reflector 18 and is also secured by the capture ring 19. In one aspect of the technology, the capture ring 19 comprises a plurality of magnets configured to allow the user to couple the device 30 to a ferrous surface. For purposes of describing the figures, housing 10 and a housing 16 are described. However, it is understood that the forward directed light assembly can be located in the same housing as the cavity that houses the electrical grid (6,7) when the device is in a closed configuration. In one aspect, the forward directed light assembly comprises on or more LEDs configured to emit/propagate “white” light or light in the spectrum most visible to the human eye, for example, 380 nm to 720 nm.

In one aspect of the technology, when the device 30 is in an open position, the device 30 is intended to be placed on a flat surface such that the capture ring 19 and/or lens 20 are adjacent the flat surface. The flat surface may be a table top or ceiling (i.e., a horizontal surface) or a wall (i.e., a vertical surface) wherein the device 30 is affixed. In an open or extended position, the slidable portion of the device 30 is extended from the cavity within housing 10. In another aspect, however, when the device 30 is in an open configuration, the device 30 is hung by handle 11. In this manner the device 30 may be in an open position. In one aspect, the lens 20 comprises a diffuser intended to soften the light emitted from the white light source disposed about a bottom of the device 30. It is important to note that the reference to “forwarded-directed white light LED” is a relative term based on the use of the device. When the device 30 is in a closed configuration, the white light source acts as a general purpose flashlight wherein the user points the device 30 in a direction that he/she wishes to illuminate. Thus, the white light source is “forward-directed.” However, in another aspect, when the device is hung, the white light source may be “downward directed.” It is understood that a white light source may also be used on other portions of the lighting device and need not necessarily be disposed about the bottom of the lighting device. Indeed, in aspects of the technology, there is no light source disposed about the bottom of the lighting device.

In one aspect of the technology, a top portion of the device 30 comprises an upper shroud or upper housing 2 that is fixed to the electrical grid (6, 7). The upper shroud 2 comprises a cavity that houses a light control board 3 and an open space for placement of a power source for powering the device 30. While the cavity within the upper housing 2 is intended to house a portable power source (e.g., conventional or rechargeable batteries), the upper housing 2 is also configured to be coupled to a fixed external power source (e.g., an outlet). In another aspect, the power source located within the upper housing 2 is coupled to an external power port intended to charge an external device such as a mobile phone. In this aspect, the portable power source used to power the device 30 can also be used as a “power bank” for other external devices.

While a cavity for the power source and power source are described as being located in the upper shroud 2, it is understood that the power source may also be located in the first housing 10 or second housing 16 or it may be from an external source such as a wall outlet. A cap 1 is disposed atop the open space of the upper shroud 2. The upper housing 2 is fixedly attached to an electrical grid/lateral light assembly. The electric grid/lateral light (i.e., an insect attracting light source) assembly comprises a lighting control shroud 4 that houses an electrical control assembly for powering the electrical grid and the light source (i.e., the UV and/or other light LED combination). In one aspect, a bottom portion of the control shroud 4 comprises a plurality of LED lights disposed about the perimeter of the shroud 4.

While the term LED is used herein in connection with a light source, it is understood that a single LED may be used as a first light source or a plurality of LEDs with similar capabilities may be used. Similar LEDs may be disposed on a similar chip or substrate or they may be disposed on different chips and different substrates and disposed about different locations of the housing as suits a particular design. Meaning, LEDs with similar characteristics may be located about numerous different locations of the device. Moreover, other light sources may be used besides LEDs.

While reference is made herein to a collapsible housing, it is understood that aspects of the technology may be used with a non-collapsible housing. Meaning, any housing that includes one or more LED lights intended to attract the insects to the trap is contemplated herein, the trap including, without limitation, an electrically conductive surface, an adhesive surface, a one-way chamber, an insect chopping chamber, or other trap accessible by insects.

In one aspect of the technology, the light sources or LEDs are configured with pulse-width modulation (“PWM”) to “dim” the LED while still attracting insects that are attracted to certain frequencies of UV radiation. PWM is one way of regulating the brightness of a light. In some aspects, using different degrees of PWM may attract different insects. Thus, in one geography a user may select a first PWM mode and in a different geography a user may select a second PWM mode. In one aspect, light emission from the LED is controlled by pulses wherein the width of these pulses is modulated to control the amount of light perceived by the end user. When the full direct current voltage runs through an LED, the maximum of light is emitted 100% of the time. That is, the LED emits light 100% of the time when in an “on” mode. With PWM, the voltage supplied to the LED can be “on” 50% of the time and “off” 50% of the time so that the LED gives off its maximum amount of light only 50% of the time. This is referred to as a 50% duty cycle. In this scenario, if the on-off cycle is modulated fast enough, human eyes will perceive only half the amount of light coming from the LED. That is, with such an input on the LED, the amount of light given off appears diminished by 50%. While specific reference is made to a 50% duty cycle, the LED duty cycle of the light sources described herein (UV and/or white LED, etc.) may be greater or lesser than 50% as suits a particular purpose. For example, the UV LED(s) and/or other LEDs propagating light at different wavelengths may have a duty cycle that ranges from 25% to 40%, 40% to 50%, 50% to 60%, and/or 60% to 75%. They may also have duty cycles that range from 20% to 25%, 25% to 30%, 30% to 35%, 35% to 40%, 40% to 45%, 45% to 50%, 50% to 55%, 55% to 60%, 60% to 65%. 65% to 70%, 70% to 75%, 75% to 80%, 80% to 85%, 85% to 90%, 90% to 95%, and/or 95% to 100%. The range may of course include more than the ranges provided herein and may include a greater range or a smaller range.

In one aspect of the technology, the on-off cycle (i.e., the rate at which the LEDs are turned on and off) is greater than about 80 to about 100 KHz. In another aspect, the on-off cycle is greater than about 100 KHz to about 120 KHz. In another aspect of the technology, the on-off cycle ranges from about 10 to about 200 KHz. In another aspect, the on-off cycle ranges from about 1 KHz to about 20 KHz. Advantageously, the device can be operating in a “dimmed” UV mode while either still providing LED white light or with the perception of little to no UV light at all. The device can also be operated in a “dimmed” white light LED mode with little or no UV light being perceived. That is, the duty cycle of the UV LED may be 100% while the duty cycle of the white light LED is less than about 100% or vice versa. In addition, both lights may be operated at about 100% of the duty cycle or both may be operated at less than about 100% of the duty cycle. Reference may be made herein to LED lights that are not pulse width modulated. Most LED lights will not be operated in a static mode, meaning they will not truly be without any pulse width modulation. For purposes of this application, an LED light is effectively static or effectively without pulse width modulation if it is modulated at a frequency less than about 2 KHz.

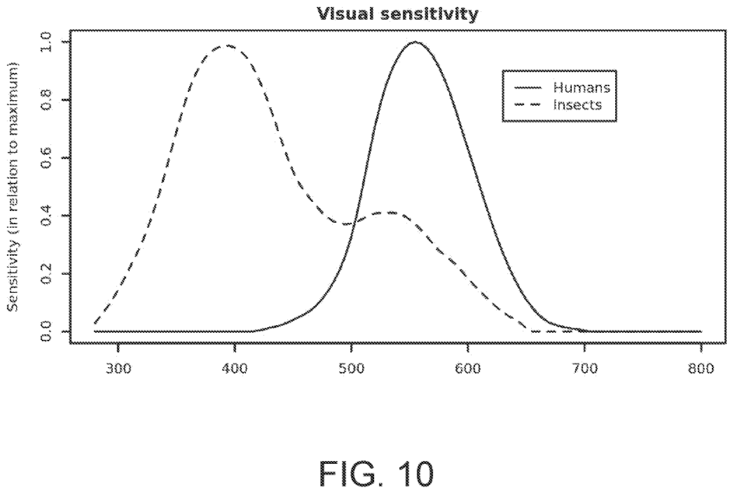

It is believed that humans and insects have a different ability to perceive different wavelengths of light. FIG. 10 is a chart that generally illustrates that principle.

For example, it is believed that the human eye can perceive light in the range from 380 nm to 720 nm, with the highest sensitivity at approximately 560 nm. It is believed that many insects have optical receptors that perceive light wavelengths in the range from 280 nm to 670 nm with the highest sensitivity at approximately 390 nm.

While different aspects of the technology are referenced herein, it is understood that one or more aspects may be combined as suits a particular purpose. In one aspect of the technology, a first light source or first LED is configured to propagate/emit a wavelength of light at about 360 nm, or ranging from about 340 nm to about 380 nm or about 350 nm to about 370 nm. A second light source or second LED is configured to propagate a wavelength of light at about 390 nm, or ranging from about 370 nm to about 410 nm, or 380 nm to about 400 nm. In one aspect of the technology, the first LED is powered at a first static power level and the second LED is powered at a second static power level. In one aspect of the technology, the power level for the first LED (the LED that is less visible to the human eye) is greater than the power level for the second LED (the LED that is more visible to the human eye). Advantageously, the end user perceives the UV LED light (the one more visible to the human eye) and understands that a UV LED light is being used to attract insects. However, the UV LED that is more perceptible to the human eye is operated at a level that requires less power consumption than the second LED that more specifically targets insects to be attracted to the device. In other words, more light (i.e., electromagnetic radiation) is emitted from the light source that is more detectable and attractive to insects than light that is detectable to the human eye.

In another aspect of the technology, a first light source or first LED is configured to propagate a wavelength of light at about 360 nm, or ranging from about 340 nm to about 380 nm, and a second light source or second LED is configured to propagate a wavelength of light at about 390 nm, or ranging from about 370 nm to about 410 nm. In one aspect of the technology, the second light source or second LED (or LED assembly) is configured to propagate light at a static power level. The first light source is configured to operate at a predetermined differing or random differing static power levels or having a pulsing pattern. It is believed that the insect may better perceive a random static power levels or pulsing patterns as movement as opposed to a static UV LED. As the first light source in this aspect is less visible to the human eye, a random or pulsing light pattern would not be a distraction or irritant to the user.

In another aspect of the technology, the lighting devices comprise a first light source or first LED configured to propagate a wavelength of light at about 360 nm, or ranging from about 340 nm to about 380 nm, and a second light source or second LED is configured to propagate a wavelength of light at about 390 nm, or ranging from about 370 nm to about 410 nm. In one aspect of the technology, the second light source or second LED (or LED assembly) is configured to propagate light at a static power level. The first light source is configured to operate having a randomized duty cycle or a preset plurality of duty cycles. Meaning, the first light source operates at a first duty cycle (e.g., 25%) for a first period of time (e.g., 5 s, 10 s, or 15 s) and then operates at a second duty cycle (e.g., 50% or more) for a second period of time (e.g., 5 s, 10 s, or 15 s). In addition, the first and second LEDs may be operated at different duty cycles in order to increase a desired effect by the user. For example, the duty cycle for the first LED could be increased while the duty cycle of the second LED is decreased. In another aspect, the duty cycle of each is substantially the same, but the number of LEDs disposed about the device is different creating a different effect for the end user and/or changing the overall power consumption of the device. That is, a first light source (e.g., the source less visible to the human eye) comprises a plurality of LEDs that are greater than the plurality of LEDs of the second light source or vice versa. The duty cycles for each light source may be the same, but the relative power consumption is different because the total number of LEDs in the light source is different.

In another aspect of the technology, the lighting devices comprise LEDs wherein a frequency of light is propagated from the LEDs for a first period of time (e.g., 5 s, 10 s, or 15 s), a second frequency of light is propagated from the LEDs for a second period of time, and a third frequency of light is propagated from the LEDs for a third period of time. The first, second, and third periods of time may be the same, or they may be different as suits a particular purpose. In an additional aspect, the different frequencies are propagated from different LEDs and not necessarily from the same LED or the same group of LEDs. For example, in one aspect, light is propagated from the lighting device from one or more LEDs at 380 nm for 5 seconds, at 390 nm for 5 seconds, and then 400 nm for 5 seconds. The light may be propagated at a static power level or a variable duty cycle.

In another aspect of the technology, the first LED or first light source comprises one or more LEDs configured to propagate light at a wavelength at about 1000 nm, ranging from about 900 nm to about 1100 nm, corresponding to the normal wavelength at which humans irradiate heat. In one aspect of the technology, the second light source (operating at a UV wavelength and/or visible light wavelength, e.g.,) is maintained at a static power level or a low duty cycle (e.g., 25% to 35%) while the first light source is maintained at a high static power level, a medium or high duty cycle (e.g., 45% to 55% or 65% to 75%, respectively), a randomized static power level, and/or randomized duty cycle, or a preset variation of static power levels or duty cycles as suits a particular purpose. It is believed that certain insects are attracted to the heat signature of the human body.

It is understood that this aspect, as well as other aspects described herein, can be used in combination with other aspects. For example, in the aspect immediately describe above (i.e., the human heat signature aspect), a third light source can be incorporated that propagates light in the UV wavelength which may be less visible or not visible at all to the human eye. Moreover, in one aspect, there may be no light source that is visible to the human eye at all. Rather, the device propagates light only in wavelengths that are not visible to the normal human eye. In still another aspect, the device may include light sources that are not visible to the human eye and are intended to attract insects, but also includes an LED configured to propagate normal white light similar to commercially available flashlights or lanterns.

While methods of operation and extermination of insects with the current technology are described above, it is noted that the current technology comprises a method of exterminating an insect and/or operating an insect extermination device that includes propagating a first wavelength of light from a housing, the first wavelength of light ranging from about 370 nm to about 410 nm at a first duty cycle and propagating a second wavelength of light from the housing concurrently with the first wavelength of light, the second wavelength of light ranging from about 340 nm to about 380 nm at a second duty cycle, the second duty cycle being greater than the first duty cycle. In one aspect, the first duty cycle is less than 50% and the second duty cycle is greater than 50%. The first and second wavelengths of light may be propagated from one or more LEDs. The method also includes providing an electric current to an electrically conductive surface disposed about the housing, the conductive surface configured to exterminate an insect when the insect contacts the conductive surface. The electrically conductive surface is an example of a trap that is used in connection with the current technology, though other traps are contemplated for use in connection with the method including an adhesive, a chamber where insects are attracted to enter but have difficulty leaving, or a chamber where the insects are destroyed by a blade or other blunt surface.

In addition to the first and second wavelengths of light, in one aspect, the method also comprises propagating a third wavelength of light ranging from about 380 nm to about 720 nm (a visible or “white” wavelength) and/or ranging from about 900 nm to about 1100 nm or about 950 nm to about 1050 nm. In one aspect the third wavelength is propagated at a duty cycle less than the duty cycle of second wavelength of light.

In an additional aspect, the method comprises adjusting the duty cycle of the second wavelength and/or the 900 nm to 1100 nm wavelength of light at predetermined time periods of time. The method further comprises maintaining the duty cycle of the first wavelength and/or the visible wavelength of light at a substantially constant duty cycle in one aspect.

It is noted that no specific order is required in these methods unless required by the claims set forth herein, though generally in some embodiments, the method steps can be carried out sequentially.

The foregoing detailed description describes the technology with reference to specific exemplary aspects. However, it will be appreciated that various modifications and changes can be made without departing from the scope of the present technology as set forth in the appended claims. The detailed description and accompanying drawing are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, the term “preferably” is non-exclusive where it is intended to mean “preferably, but not limited to.” Any steps recited in any method or process claims may be executed in any order and are not limited to the order presented in the claims. Accordingly, the scope of the invention should be determined solely by the appended claims and their legal equivalents, rather than by the descriptions and examples given above.

1. A device for use in connection with the extermination of insects, comprising:
a housing;
a power source coupled to the housing;
an insect trap disposed about the housing;
a first light source coupled to the power source, the first light source configured to propagate a wavelength of light ranging from about 370 nm to about 410 nm at a first duty cycle; and
a second light source coupled to the power source, the second light source configured to propagate a wavelength of light ranging from about 340 nm to about 380 nm at a second duty cycle;
wherein the amount of light emitted from the second light source is greater than the amount of light emitted from the first light source.

2. The device of claim 1, wherein the first duty cycle is different than the second duty cycle.

3. The device of claim 1, further comprising a third light source configured to propagate a wavelength of light ranging from about 380 nm to about 720 nm, wherein the third light source is configurable to operate at a plurality of duty cycles.

4. The device of claim 1, wherein the duty cycle of the first and second light sources are adjustable.

5. The device of claim 1, wherein the duty cycle of the second light source is changed at predetermined time periods.

6. The device of claim 1, wherein the first and second light sources comprise one or more LEDs.

7. The device of claim 1, wherein the second light source is disposed adjacent the trap.

8. The device of claim 1, wherein the first light source is not disposed adjacent the trap.

9. The device of claim 1, further comprising a third light source configured to propagate light at a frequency ranging from about 900 nm to about 1100 nm.

10. The device of claim 1, wherein the trap comprises an electrically conductive surface configured to exterminate an insect when the insect contacts the conductive surface, a chamber for dehydrating or hitting insects, or an adhesive for retaining insects that come into contact with the adhesive.

11. A device for use in connection with the extermination of insects, comprising:
a housing;
a power source coupled to the housing;
an insect trap disposed about the housing;
a first light source configured to propagate a wavelength of light ranging from about 370 nm to about 410 nm at a plurality of first duty cycles for a pre-determined time period, the plurality of first duty cycles; and
a second light source configured to propagate a wavelength of light ranging from about 340 nm to about 380 nm at a second duty cycle;
wherein the amount of light emitted from the second light source is greater than the amount of light emitted from the first light source.

12. The device of claim 11, wherein the predetermined time period comprises a plurality of time periods comprising 5 s and 10 s.

13. The device of claim 11, wherein the plurality of first duty cycles for the first light source comprises 25% to 35% and 35% to 45%.

14. The device of claim 11, wherein the second light source is operated at a substantially constant duty cycle.

15. The device of claim 11, further comprising a third light source configured to propagate wavelengths of light ranging from about 380 nm to about 720 nm.

16. The device of claim 11, further comprising a control coupled to the housing, the control configured to permit a user to activate the first and second light sources.

17. A device for use in connection with the extermination of insects, comprising:
a housing coupled to a power source;
an insect trap disposed about the housing;
a first plurality of LEDs disposed about the housing, the first plurality of LEDs configured to propagate a wavelength of light ranging from about 380 nm to about 400 nm, the first plurality of LEDs having a first duty cycle;
a second plurality of LEDs disposed about the housing, the second plurality of LEDs configured to propagate at wavelength of light ranging from about 380 nm to about 720 nm having a second duty cycle; and
wherein the amount of light propagated from the first plurality of LEDs is greater than the amount of light propagated from the second plurality of LEDs.

18. The device of claim 17, further comprising a third plurality of LEDs configured to propagate a wavelength of light less than 380 nm, the amount of light propagated from the third plurality of LEDs being greater than the amount of light propagated from the first and second plurality of LEDs.

19. The device of claim 17, further comprising a third plurality of LEDs configured to propagate a wavelength of light ranging from about 900 nm to about 1100 nm, the amount of light propagated from the third plurality of LEDs being greater than the amount of light propagated from the first and second plurality of LEDs.

20. The device of claim 17, wherein the number of LEDs in the first plurality of LEDs is greater than the number of LEDs in the second plurality of LEDS.

21.-32. (canceled)
